(19) United States
(12) Patent Application Publication
(10) Pub. No.: US 2009/0067027 A1
(43) Pub. Date: Mar. 12, 2009

(54) Liquid space telescope

(76) Inventor: Michael Ross Hennigan, Beaumont, TX (US)

Correspondence Address: MICHAEL ROSS HENNIGAN, HC 1 BOX 514, ANAHUAC, TX, 77514, US

(21) Appl. No.: 11/899,582

(22) Filed: Sep. 7, 2007

(51) Int. Cl. G02B 26/02; G02B 23/00; G02B 5/08

(52) U.S. Cl. 359/228; 359/422; 359/230; 359/846

(57) ABSTRACT

The invention in microgravity uses the natural effect of capillary action and surface tension of a liquid substance inside a cylindrical chamber to form a curved meniscus suitable to use in a space telescope. The geometry of the meniscus can be controlled by using a boundary line that fixes the contact point of the meniscus and then controlling the volume of the liquid. The meniscus geometry can then be controlled to form a reflective liquid mirror dish that is suitable to use in a space telescope.

### REFERENCES CITED

### U.S. Patent Documents

| | | | |
|---|---|---|---|
| 5,650,880 | Jul. 22, 1997 | Shuter, et al. | 359/846 |

### FIELD OF THE INVENTION

The invention relates generally to space telescopes and the images produced and more particularly to mirror dishes used in space telescopes to produce images. The invention is a new and novel concept that in microgravity uses the natural effect of capillary action and surface tension of a liquid substance in a cylindrical container to form a curved meniscus that can then be used as a microgravity liquid mirror dish.

### BACKGROUND OF THE INVENTION

Current liquid telescopes are designed to operate in a gravity environment. By rotating a dish filled with a liquid like mercury the meniscus will form a parabolic geometry suitable for a primary reflective dish. However, this technology is limited to zenith, straight up. In contrast, the invention is designed to work in microgravity using capillary action and can work in any direction. Additionally, the invention may supersede the size limitation off current telescope technologies.

### BRIEF SUMMARY OF THE INVENTION

The invention in microgravity uses the natural effect of capillary action and surface tension of a liquid substance like liquid gallium, gallium alloys, mercury, mercury alloys and many other suitable liquids meeting a substance like air inside a cylindrical chamber to form a curved meniscus suitable to use in a space telescope. The geometry of the meniscus can be controlled by using a boundary line that fixes the contact point of the meniscus and then controlling the volume of the liquid. The meniscus geometry can then be controlled to form a reflective liquid mirror dish that is suitable to use in a space telescope. The invention may have various other applications including but not limited to focusing light from the sun or other sources to be used as a propulsion system by focusing the light directly or indirectly on to a spacecraft. The invention can be used to focus light energy from the sun or other sources to transmit energy to the Earth's surface or other locations. The invention can be used to form a powerful microscope or similar device. The inventions variable focus capability can be used to focus radio, microwave and light waves for communication purposes.

### BRIEF DESCRIPTION OF THE DRAWINGS

Other objects and many additional advantages will be more readily understood by those skilled in the art after a detailed consideration of the following specification taken with the accompanying drawings wherein:

FIG. 1-30 are all cross sectional views of the invention.

### DETAILED DESCRIPTION OF THE EMBODIMENTS

### Embodiment 1

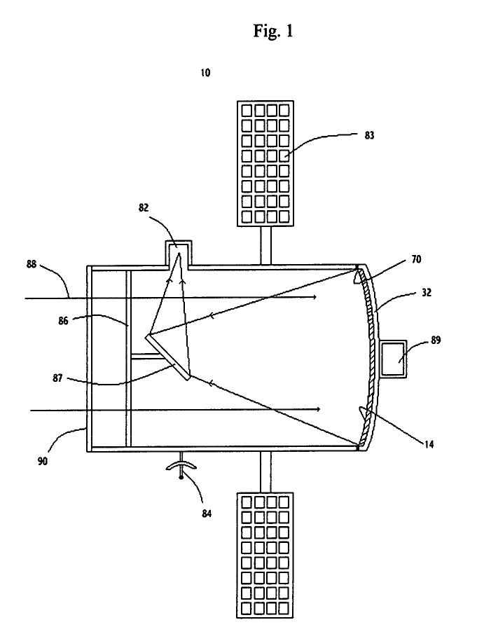

As shown in FIG. 1 the invention (10) is comprised of a meniscus (14) that is a primary reflective mirror dish. The boundary line (70) stops the capillary action rise of the meniscus (14). The dish chamber (32) is the main body of the telescope. The aperture cover (90) is transparent. The support (86) supports the secondary mirror. The secondary mirror (87) reflects the light (88) from the primary mirror to the scientific package (82). One or more solar panels (83) can provide electrical power to the system. A radio antenna (84) can send and receive data. A spacecraft platform (89) can propel the invention.

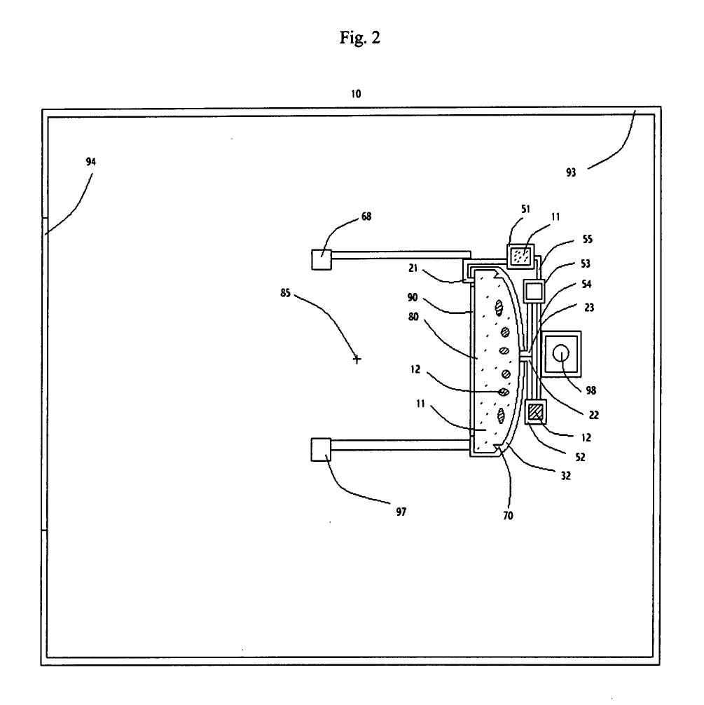

As shown in FIG. 2 the invention (10) is comprised of two or more substances contained in the dish chamber (32). The gas substance (11) can be composed of any gas or liquid as long as it is less dense than the liquid substance (12) and has the property of being transparent to the waves being observed. The heavier liquid substance (12) can be composed of any liquid as long as it is denser than gas substance (11) and has the property of being reflective to the waves being observed. The gas pump (21) has the means to pump gas substance (11) from the gas chamber (51) into the dish chamber (32) or pump the gas substance (11) from the dish chamber (32) into the gas chamber (51). The liquid pump (22) can pump the liquid substance (12) from the liquid chamber (52) into the dish chamber (32) or pump the liquid substance (12) from the dish chamber (32) into the liquid chamber (52). The dish chamber (32) has a form similar to a dish. The dish chamber (32) has a lip (70) that extends toward inner aperture cover (90). The edges of the lip (70) form a circle. An aperture (80) is formed which is circular in form. The dish chamber (32) would have an inner aperture cover (90) that would allow waves being observed to pass thru to intersect with the meniscus (14) and be reflected back out thru the inner aperture cover (90). The inner aperture cover (90) would be composed of a material transparent to the waves being observed. The dish chamber can be elongated so that a secondary dish can be inside the dish chamber (32). A momentum wheel (98) that has means to exchange angular momentum with the rest of the system.

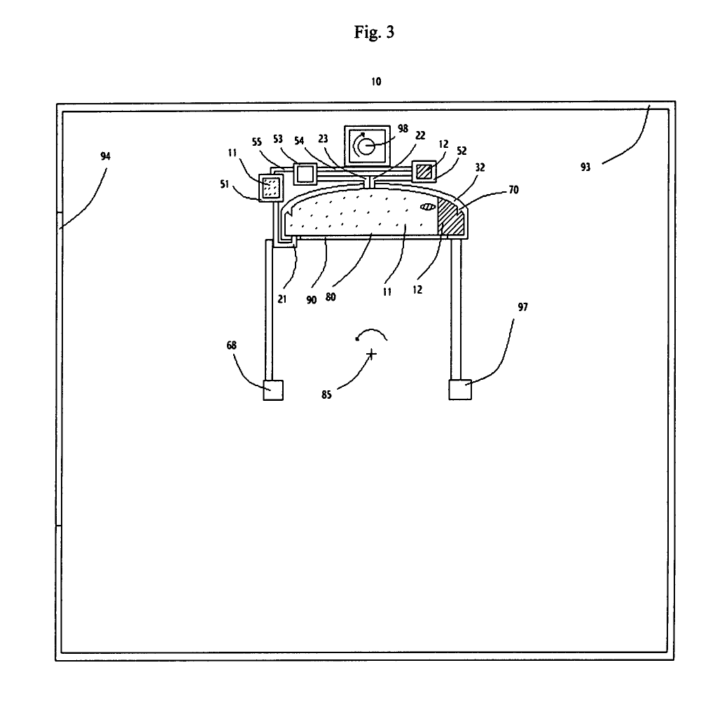

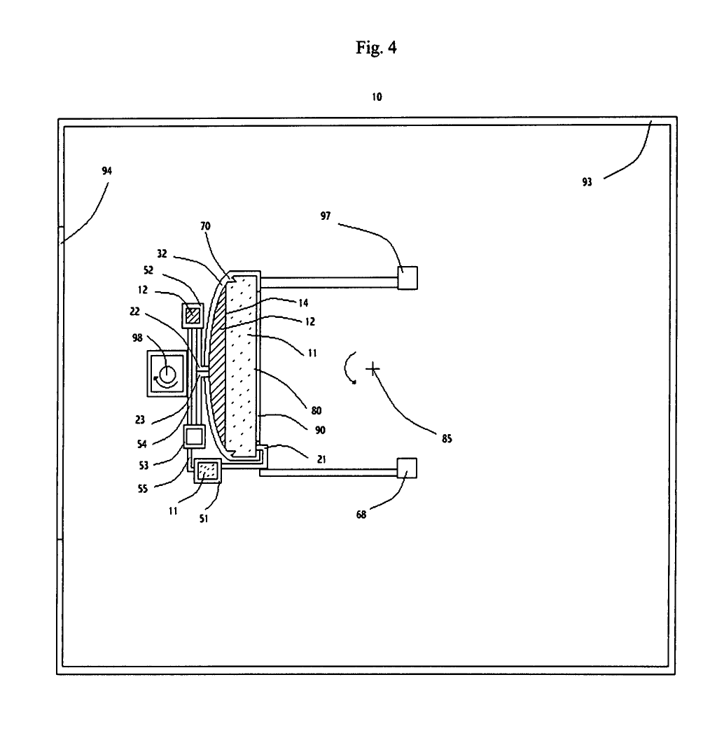

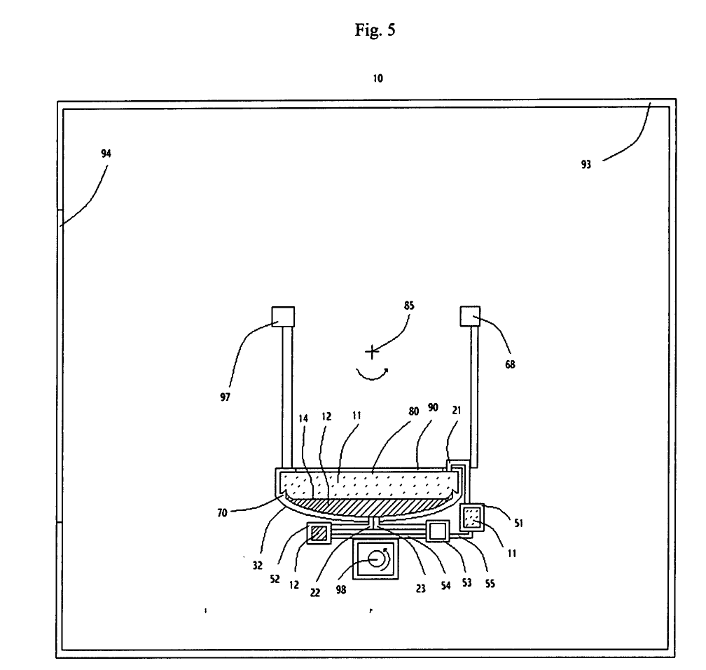

As shown in FIG. 3 and FIG. 4 once in microgravity, the momentum wheel (98) would begin to rotate. Therefore, the momentum wheel (98) would exchange angular momentum with the rest of the system. This would cause the system to rotate in the opposite direction of the momentum wheel (98) about the center of mass of the system (85). Therefore, due to centrifugal force the heavier more dense liquid substance (12) would be forced to collect at the bottom of the dish chamber (32) that is the portion of dish chamber (32) that is most far away from the center of mass (85). After the liquid substance (12) has been allowed to settle as shown in FIG. 4 the momentum wheel (98) begins to slow down. Therefore, the momentum wheel (98) would exchange angular momentum with the rest of the system. This would cause the rotation of the system about the center of mass (85) to slow down. Therefore, less centrifugal force is applied to gas substance (11) and liquid substance (12).

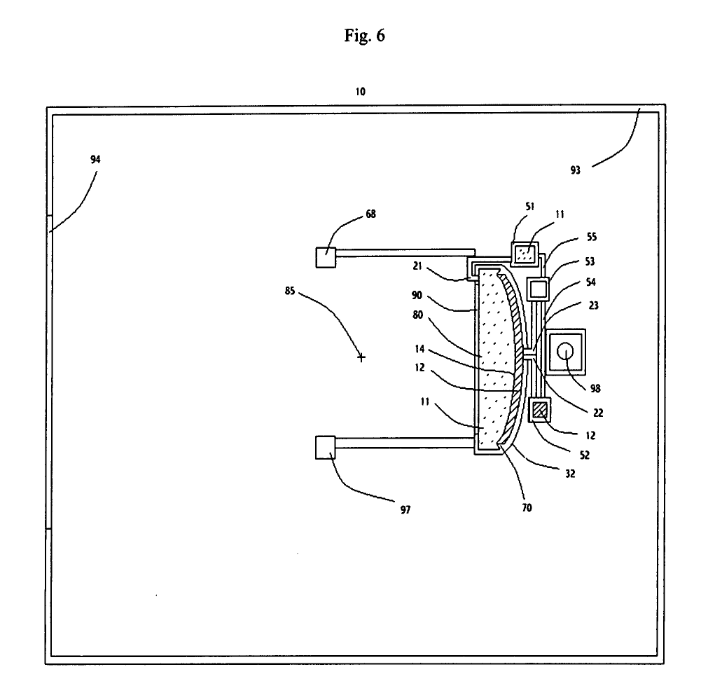

Furthermore, this would cause the meniscus (14) to begin to alter its shape as it tries to climb the wall of dish chamber (32). As shown in FIG. 6 when the systems rotation about the center of mass (85) slowly comes to a stop the meniscus (14) would reach the lip (70). Because the lip (70) ends there is no place for the meniscus (14) to go so the shape or geometry of the meniscus (14) would be determined by the amount of each of the gas substance (11) and liquid substance (12) contained in dish chamber (32). If at that point a different shape was desired then the gas pump (21) would very slowly pump the gas substance (11) from the dish chamber (32) into the gas chamber (51). Simultaneously, the liquid pump (22) would very slowly pump the liquid substance (12) from the liquid chamber (52) into the dish chamber (32) or the gas pump (21) would very slowly pump the gas substance (11) from the gas chamber (51) into the dish chamber (32). Simultaneously, the liquid pump (22) would very slowly pump the liquid substance (12) from the dish chamber (32) into the liquid chamber (52). Therefore, the geometry of the meniscus (14) would begin to alter and this would allow for the meniscus (14) geometry to be controlled. Once the desired geometry is achieved the gas pump (21) and the liquid pump (22) would stop pumping.

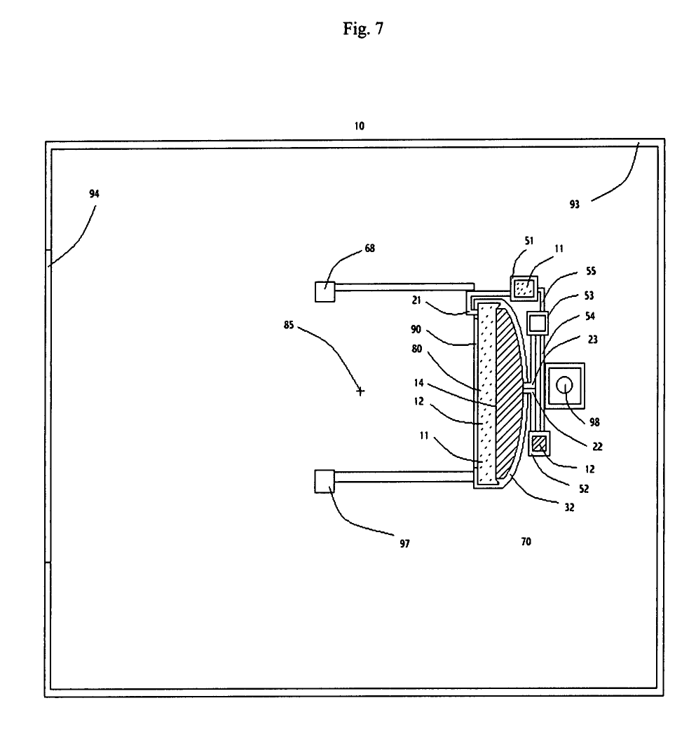

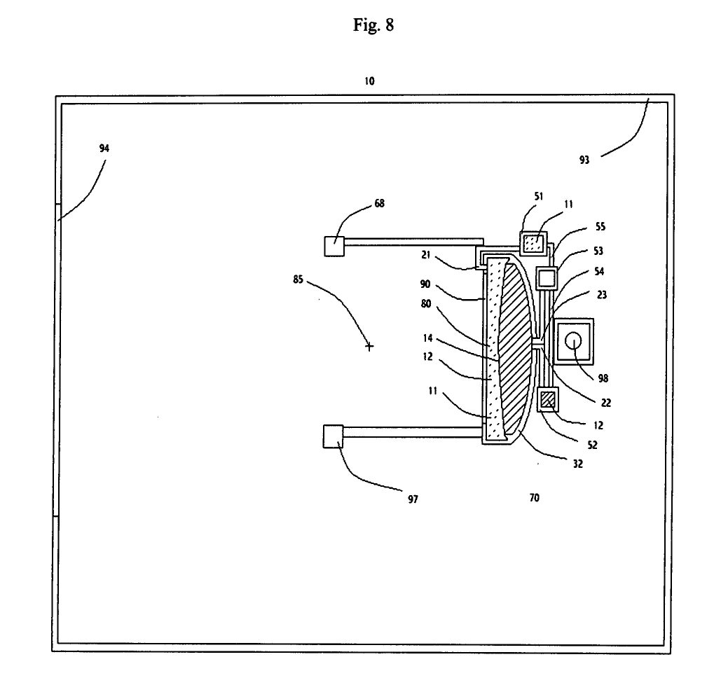

As shown in FIG. 6 the invention can produce a concave liquid reflective mirror dish. As shown in FIGS. 7 and 8 the invention can continue to expand the meniscus (14) to form a flat reflective surface or a convex reflective surface.

In this embodiment of the invention if the shape of the mirror was already predetermined and did not need to change then pumps (21), (22), (23), chambers (51), (52), (53) and tubes (54) and (55) would not be necessary. Additionally, only the needed amount of the gas substance (11) and the liquid substance (12) to form the liquid mirror dish would be needed. This could greatly reduce the overall mass of the system.

This embodiment can also use acceleration and deceleration of the system instead of centrifugal force to control the substances. Propellant can be used or a mass that does not leave the system can move to create acceleration and slow down to deceleration of the system.

The invention has the means to alter the position of the center of mass of the invention. During rotation of the system the center of mass of the system would be further out away from the meniscus (14). However after the meniscus (14) formed the desired geometry the invention has the means to change the position of the center of mass of the invention.

### Embodiment 2

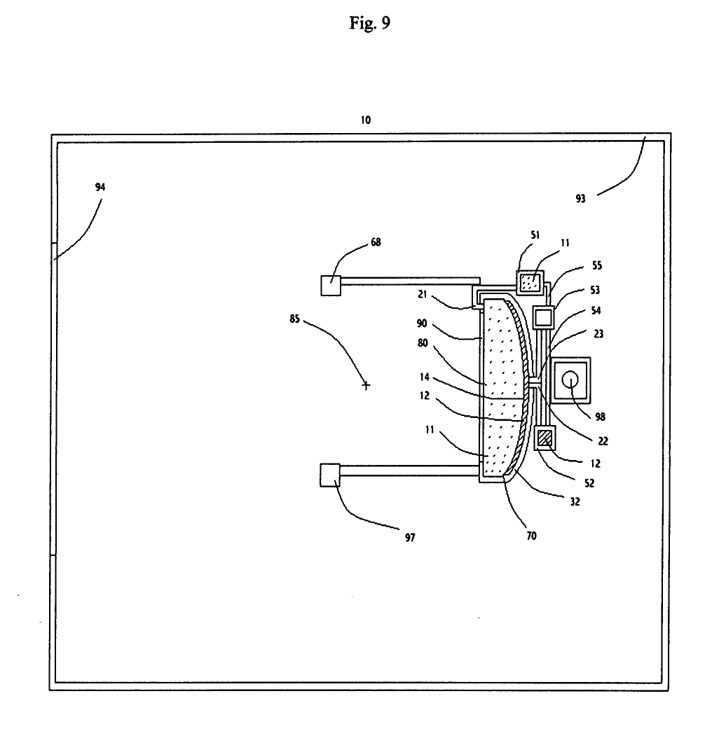

As shown in FIG. 9 embodiments 2 of the invention works the same as embodiments 1 except that the lip (70) is a recessed ledge that encircles the interior of dish chamber (32).

### Embodiment 3

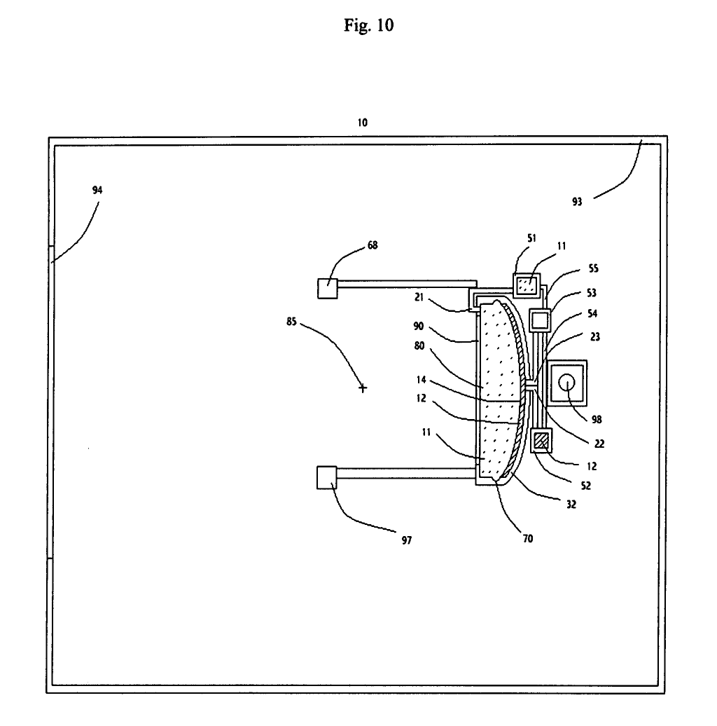

As shown in FIG. 10 embodiment 3 of the invention works the same as embodiment 1 except that the lip (70) is a recessed indented half spherical ring that encircles the interior of dish chamber (32). When the liquid substance (12) reaches the lip (70) the liquid substance has no wear to go so said lip (70) acts as a boundary line.

### Embodiments 4

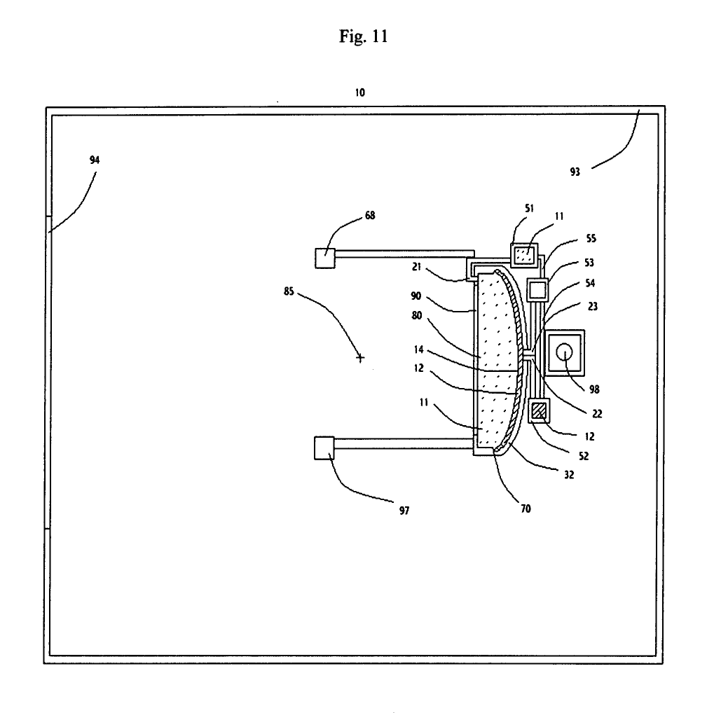

As shown in FIG. 11 embodiment 4 of the invention works the same as embodiment 1 except that the lip (70) is a recessed indented half spherical ring that encircles the interior of dish chamber (32). When the liquid substance (12) is in contact with the lip at different points the various contact angles will produce various degrees of curvature or geometry of the meniscus (14).

### Embodiments 5

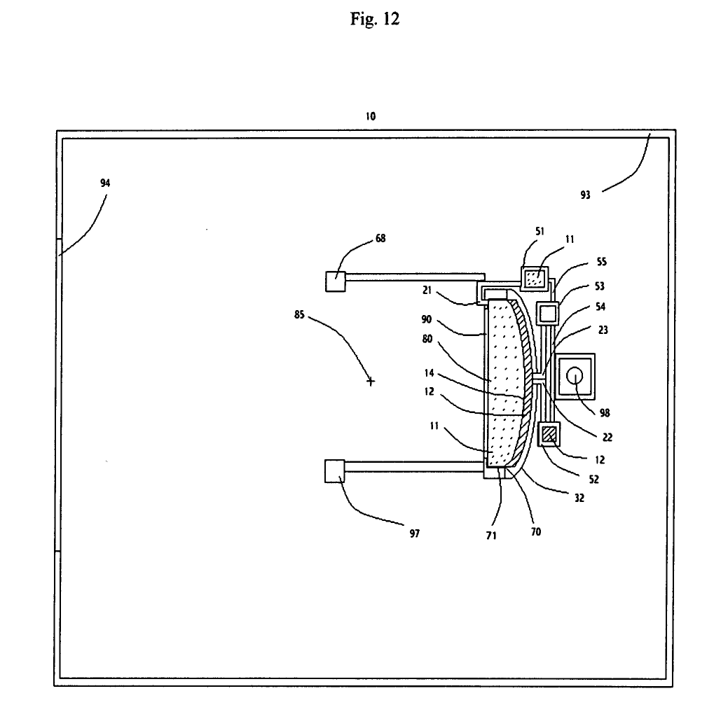

As shown in FIG. 12 embodiment 5 of the invention works the same as embodiment 1 except that the boundary line consist of the bottom section of the dish chamber being constructed of a material and or coated in a material that wets the liquid substance (12) and a circular boundary line about the interior of the dish chamber transitions to being constructed of a material and or coated in a material that does not wet the liquid substance (12). The meniscus geometry can then be controlled by altering the volume of the liquid substance (12) in the dish chamber (32). All the surfaces of the interior of the dish chamber (32), liquid space telescope and outer shell (93) that doses not contact the liquid substance (12) when forming a dish can be constructed of a material and or coated in a material that dose not wet the liquid substance (12).

### Embodiment 6

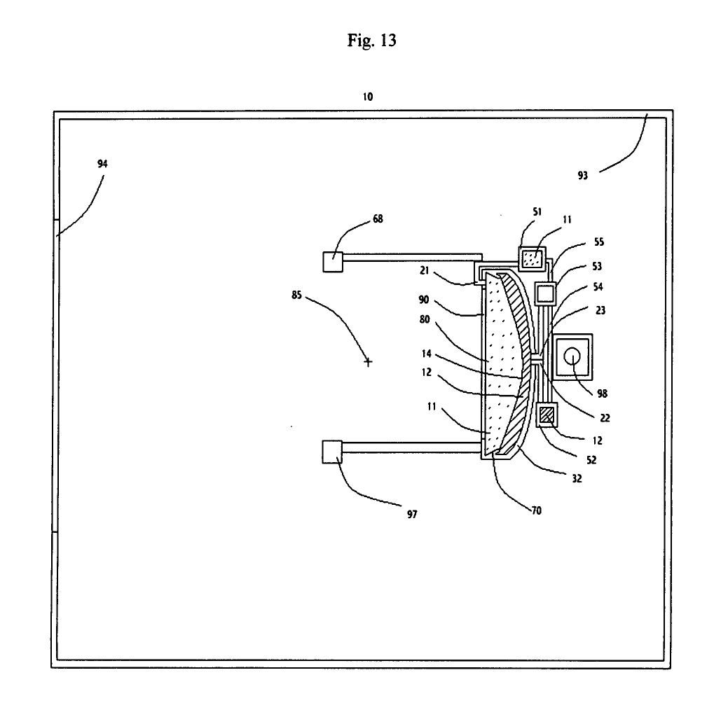

As shown in FIG. 13 embodiment 6 of the invention works the same as embodiment 1 except that the boundary line consists of a lip (70) that extends inward towards the center of the dish chamber (32) at an angle ranging from 1 degree to 179 degrees.

### Embodiment 7

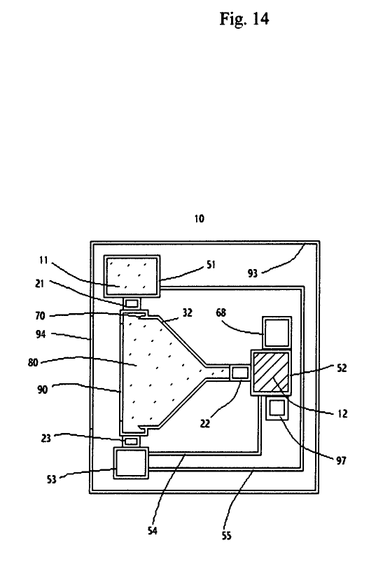

As shown in FIG. 14 the invention (10) is comprised of two or more substances contained in chambers. The light gas substance (11) can be composed of any gas or liquid as long as it is less dense than liquid substance (12) and has the property of being transparent to the waves being observed. The heavier liquid substance (12) can be composed of any liquid as long as it is denser than gas substance (11) and has the property of being reflective to the waves being observed. Before reaching microgravity gas substance (11) is contained within the gas chamber (51). The gas pump (21) has the means to pump the gas substance (11) from the gas chamber (51) into the dish chamber (32) or pump the gas substance (11) from the dish chamber (32) into the gas chamber (51). Before reaching microgravity the liquid substance (12) is contained within the liquid chamber (52). The liquid pump (22) can pump the liquid substance (12) from the liquid chamber (52) into the dish chamber (32) or pump the liquid substance (12) from the dish chamber (32) into the liquid chamber (52). The dish chamber (32) has a form similar to a standard funnel being cylindrical in form with an increasing radius. The dish chamber (32) has a lip (70) that extends toward inner aperture cover (90). The edge of lip (70) forms a circle. An aperture (80) is formed which is circular in form. The dish chamber (32) would have an inner aperture cover (90). The inner aperture cover (90) would allow waves to pass thru to intersect with the meniscus (14) and be reflected back out thru the inner aperture cover (90). The inner aperture cover (90) would be composed of a material transparent to the waves being observed. The dish chamber (32) can be elongated so that a secondary mirror can be inside the dish chamber (32).

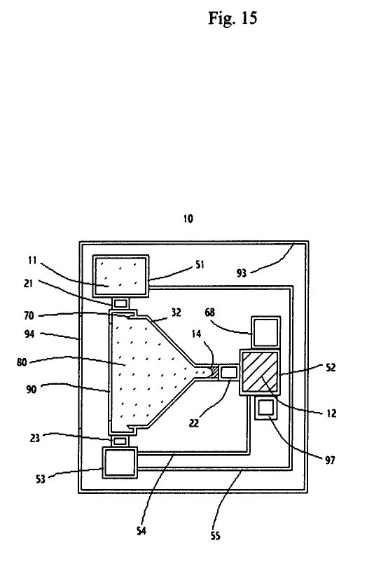

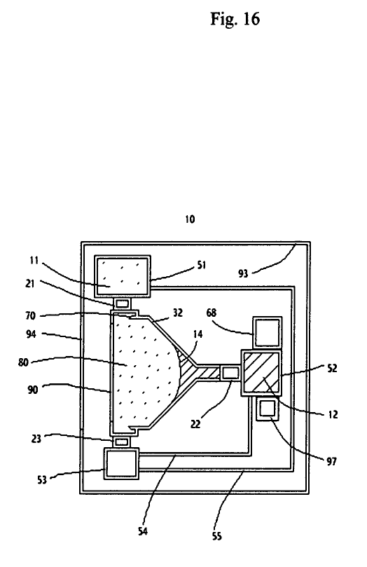

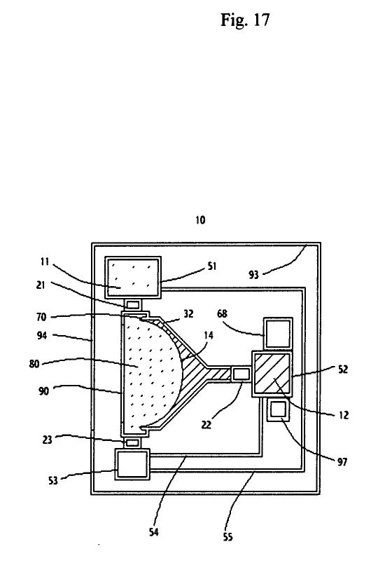

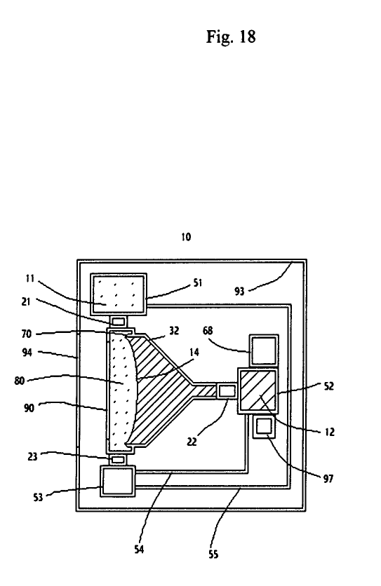

As shown in FIG. 15 once in microgravity the gas pump (21) would very slowly pump the gas substance (11) from the dish chamber (32) into the gas chamber (51). Simultaneously, the liquid pump (22) would very slowly pump the liquid substance (12) from the liquid chamber (52) into the dish chamber (32). Due to the small radius of dish chamber (32) where gas substance (11) and liquid substance (12) initially meet a ½ bubble takes form at that point. This is due to capillary action and surface tension that causes a spherical meniscus (14) to form. As shown in FIG. 16 pumps (21) and (22) would pump gas substance (11) and liquid substance (12) at a rate that would maintain the bond between the meniscus (14) and the wall of dish chamber (32) and would cause the meniscus (14) to move forward towards aperture (80). The meniscus (14) would grow in size as it moves forward due to the increasing radius of the dish chamber (32). As shown in FIG. 17. when the meniscus (14) reaches the end or tip of lip (70) said meniscus (14) can not move forward because there is nothing else for the meniscus (14) to bond to. As shown in FIG. 18 the meniscus (14) would begin to alter it's geometry to be more flat. This would allow for many different amounts of curvature to be achieved. Once the desired shape is achieved pumps (21) and (22) would stop pumping.

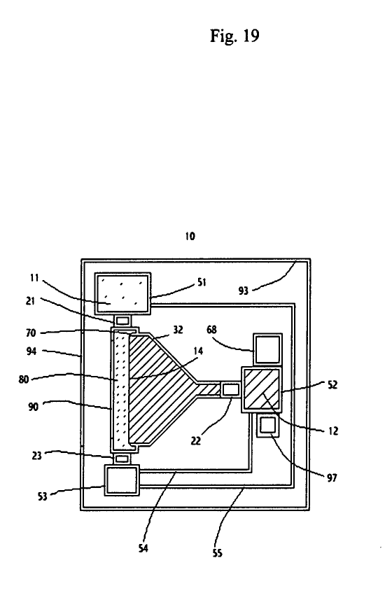

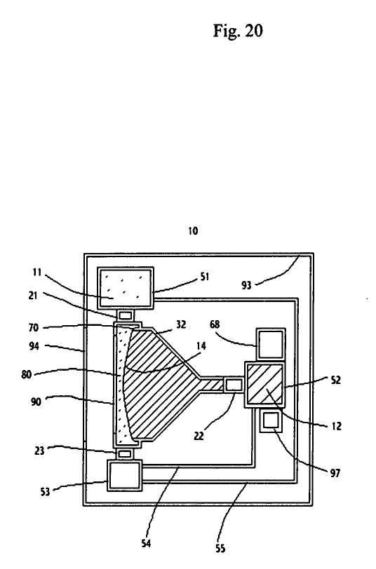

As shown in FIG. 18 the invention can produce a concave reflective mirror dish. As shown in FIGS. 19 and 20 the invention can continue to expand the meniscus (14) to form a flat reflective surface or a convex reflective surface.

### Embodiment 8

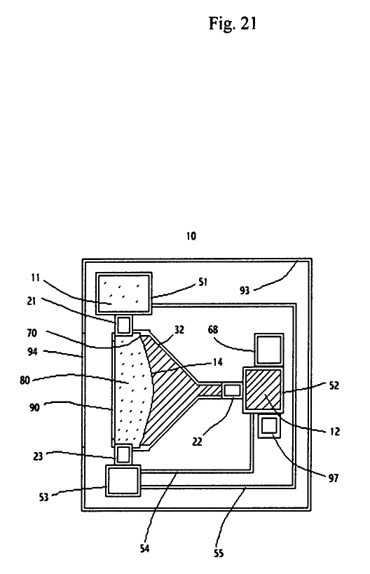

As shown in FIG. 21 embodiment 8 of the invention works the same as embodiment 7 except that the lip (70) is a recessed ledge that encircles the interior of dish chamber (32).

### Embodiments 9

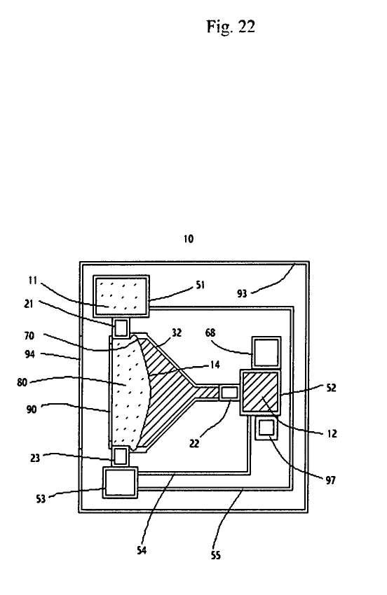

As shown in FIG. 22 embodiment 9 of the invention works the same as embodiment 7 except that the lip (70) is a recessed indented half spherical ring that encircles the interior of dish chamber (32).

### Embodiments 10

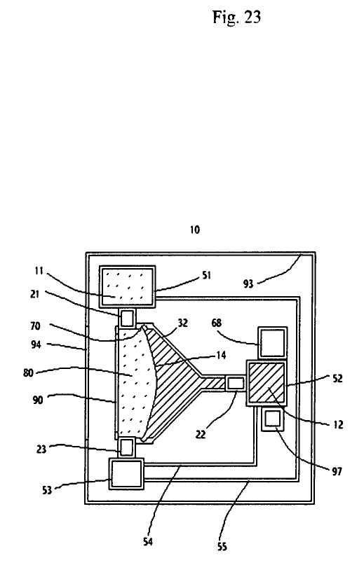

As shown in FIG. 23 embodiment 10 of the invention works the same as embodiment 7 except that the lip (70) is a recessed indented half spherical ring that encircles the interior of dish chamber (32). When the liquid substance (12) is in contact with the lip (70) at different points the various contact angles will produce various degrees of curvature or geometry of the meniscus (14).

### Embodiments 11

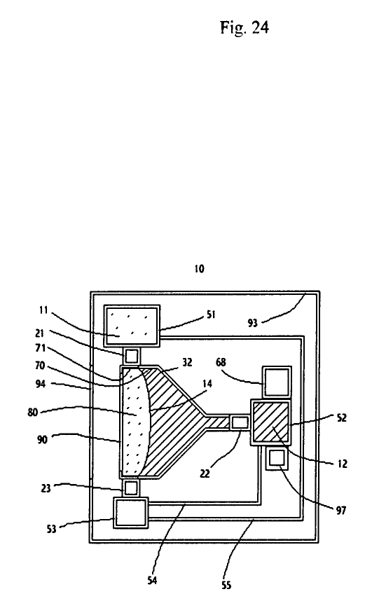

As shown in FIG. 24 embodiment 11 of the invention works the same as embodiment 7 except that the boundary line consist of the bottom section of the dish chamber being constructed of a material and or coated in a material that wets the liquid substance (12) and a circular boundary line about the interior of the dish chamber that transitions to being constructed of a material and or coated in a material that does not wet the liquid substance (12), and the meniscus geometry can then be controlled by altering the volume of the liquid substance (12) in the dish chamber (32). All surfaces of the interior of the dish chamber (32), liquid space telescope and outer shell (93) that doses not contact the liquid substance (12) when forming a dish can be constructed of a material and or coated in a material that dose not wet the liquid substance (12).

### Embodiments 13

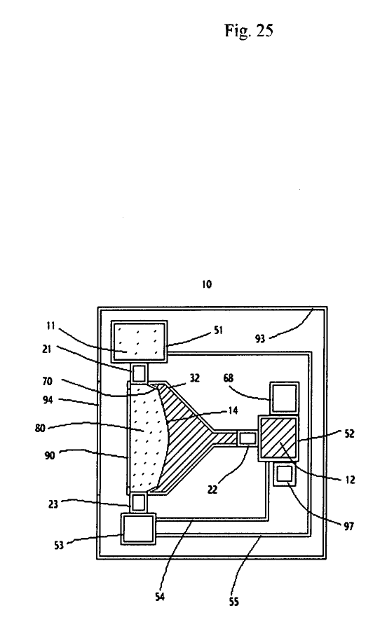

As shown in FIG. 25 embodiment 13 of the invention works the same as embodiment 7 except that the boundary line consists of a lip (70) that extends inward towards the center of the dish chamber (32) at an angle ranging from 1 degree to 179 degrees.

### Embodiment 14

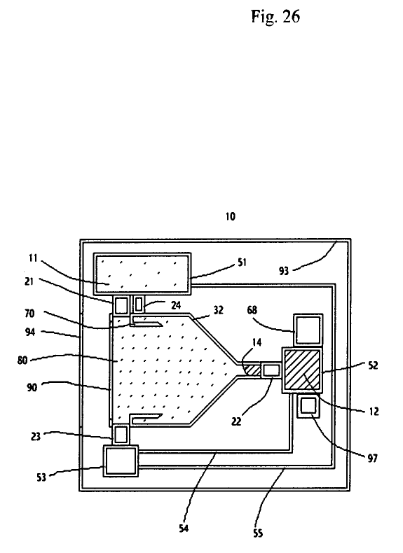

As shown in FIG. 26 the invention (10) is comprised of two or more substances contained in chambers. The light gas substance (11) can be composed of any gas or liquid as long as it is less dense than the liquid substance (12) and has the property of being transparent to the waves being observed. The heavier liquid substance (12) can be composed of any liquid as long as it is denser than the gas substance (11) and has the property of being reflective to the waves being observed. Before reaching microgravity the gas substance (11) is contained within the gas chamber (51) and the dish chamber (32). The gas pump (21) has the means to pump the gas substance (11) from the gas chamber (51) into the dish chamber (32) or pump the gas substance (11) from the dish chamber (32) into the gas chamber (51). Before reaching microgravity the liquid substance (12) is contained within the liquid chamber (52). The liquid pump (22) can pump the liquid substance (12) from the liquid chamber (52) into the dish chamber (32) or pump the liquid substance (12) from the dish chamber (32) into the liquid chamber (52). The dish chamber (32) has a form similar to a standard funnel being cylindrical in form with a increasing radius. The dish chamber (32) has a lip (70) that extends inward towards the center of dish chamber (32). Then, the lip (70) extends away from the inner aperture cover (90). The edge of the lip (70) forms a circle. The aperture (80) has a circular form. The dish chamber (32) would have an inner aperture cover (90). The inner aperture cover (90) would allow waves to pass thru to intersect with the meniscus (14) and be reflected back out thru the inner aperture cover (90). The inner aperture cover (90) would be composed of a material transparent to the waves being observed. For example, in a system observing only visible light the inner aperture cover (90) can be covered in glass. The covering of the aperture is necessary to maintain desired pressure in dish chamber (32).

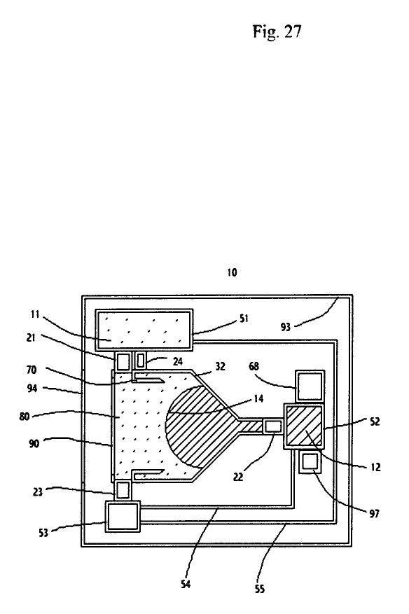

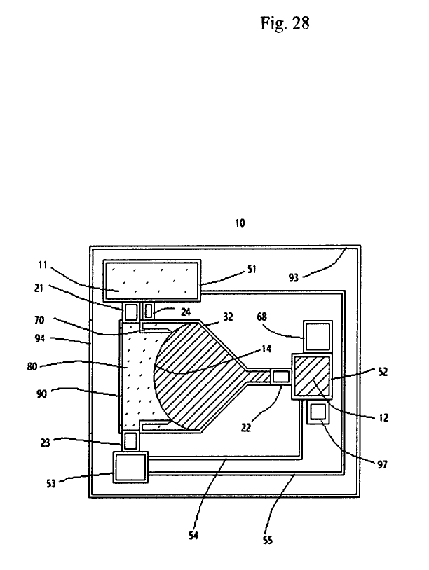

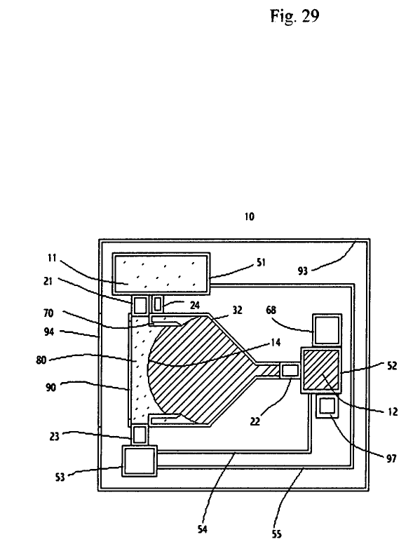

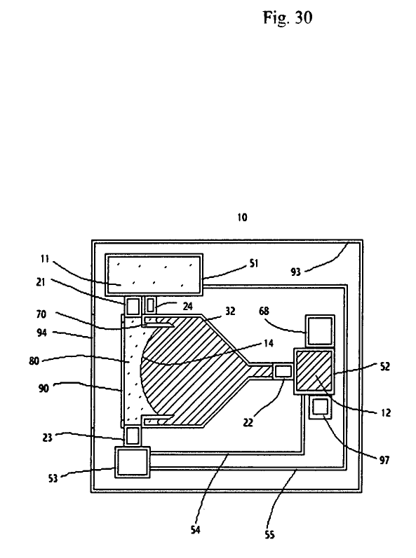

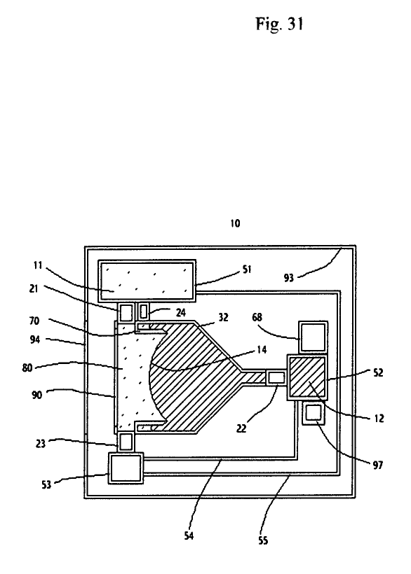

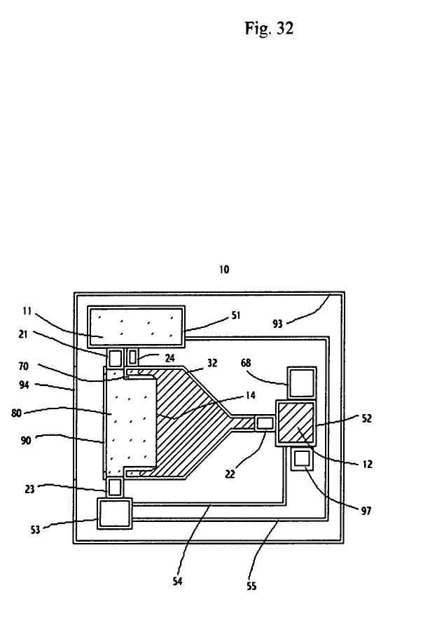

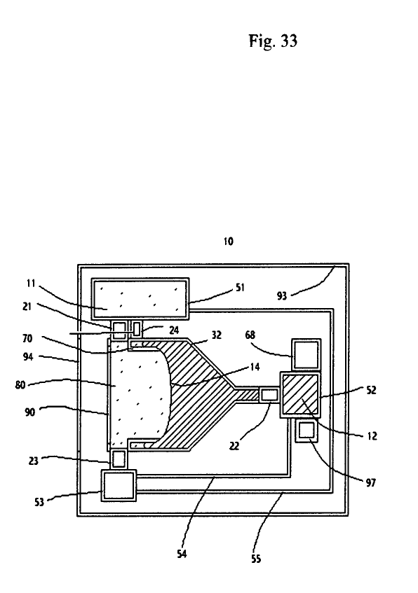

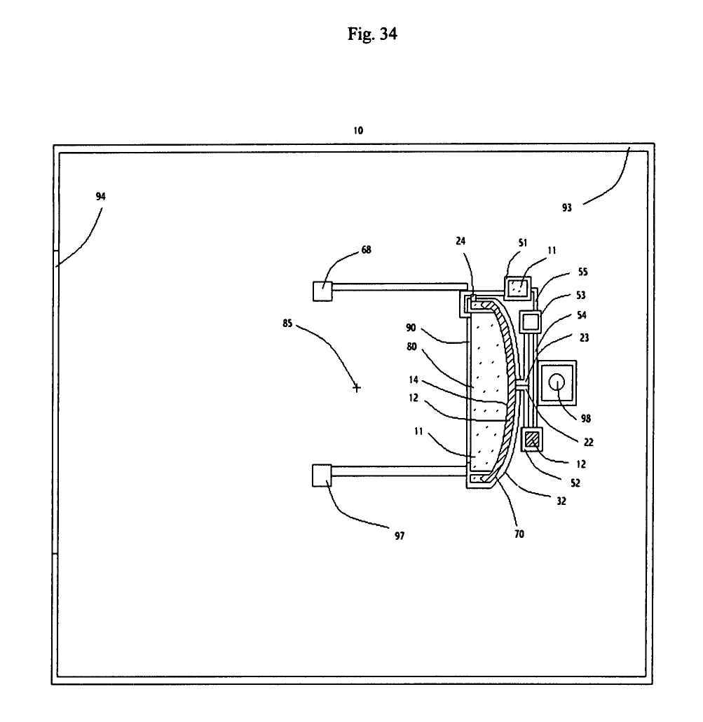

As shown in FIG. 27 once in microgravity the gas pump (21) would very slowly pump the gas substance (11) from the dish chamber (32) into the gas chamber (51). Simultaneously, the liquid pump (22) would very slowly pump the liquid substance (12) from the liquid chamber (52) into the dish chamber (32). Due to the small radius of dish chamber (32) where the gas substance (11) and the liquid substance (12) initially meet a ½ bubble takes form at that point. This is due to capillary action and surface tension that causes a meniscus (14) to form. As shown in FIG. 28 pumps (21) and (22) would pump the gas substance (11) and the liquid substance (12) at a rate that would maintain the bond between the meniscus (14) and the wall of dish chamber (32) and would cause the meniscus (14) to move forward towards the aperture (80). The meniscus (14) would grow in size as it moves forward due to the increasing radius of dish chamber (32). As shown in FIG. 29. when the meniscus (14) reaches the end or tip of the lip (70) said meniscus (14) can not move forward into the area that surrounds or is about the lip (70). As shown in FIG. 30 the secondary gas pump (24) pumps gas substance (11) from the area surrounding the lip (70) into gas chamber (51) that allows liquid substance (12) to move into the area that surrounds or is all about lip (70).

As shown in FIGS. 31 and 32 the gas pump (21) would very slowly pump the gas substance (11) from the gas chamber (51) into the dish chamber (32). Simultaneously, the liquid pump (22) would very slowly pump the liquid substance (12) from the dish chamber (32) into the liquid chamber (52). This would cause the meniscus (14) to reverse direction.

As shown in FIG. 33 the geometry of the meniscus (14) would begin to form a concave meniscus. Once the desired shape is achieved the pumps (21), (22), and (24) would stop pumping.

### Embodiment 15

As shown in FIG. 34 embodiment 15 of the invention works the same as embodiment 1 except that the lip (70) is configured like embodiment 14.

The following can apply to some or all of the embodiments of the invention:

It should be understood that there are many different ways in which a reflective telescope can be configured. Therefore, only the actual methodology to form and control the geometry of a microgravity liquid mirror dish is discussed and disclosed.

A complete telescope design using the invention can utilize more than one microgravity liquid mirror dish. The primary, secondary and any additional relay dishes can be contained in the same dish chamber (32). Therefore, only one inner aperture cover (90) is necessary.

The invention would have a spacecraft platform (89) that has one or more thrusters and or any means of propulsion that can propel the liquid space telescope to a desired location and can provide a steady thrust that counteracts the effects of perturbations making the liquid space telescope experience virtual zero gravity and can provide a steady thrust during turning maneuvers so as to cause the liquid substance to move to the bottom of the dish chamber below the boundary line to stabilize the liquid substance during the turning maneuver and can be controlled automatically via the main computer and or a remote human controller.

The invention would have one or more main computers and associated software that can control and operate all functions of the invention and or relay commands from a remote human controller through a connection to the spacecraft transceiver.

The invention would have a power system, such as solar panels, batteries, fuel cell, nuclear power plant, that can provide electrical power to all parts of the invention that require electrical power.

The invention would have one or more spacecraft attitude control sensor systems that can be controlled automatically via the main computer and or a remote human controller.

The invention would have one or more spacecraft attitude control actuator systems that can be controlled automatically via the main computer and or a remote human controller.

The invention would have one or more spacecraft transceiver communication systems that can relay data to and from the spacecraft and another transceiver at a distant location and can be controlled automatically via the main computer and or a remote human controller.

The liquid substance (12) can have pigmentation added to it to cause it to be dark or non-transparent so that the only reflection comes off of the meniscus (14).

The invention can have a third intermediate substance being less dense than the gas substance (11) and denser than the liquid substance (12) and can be between the gas substance (11) and the liquid substance (12). The intermediate substance can have the property of being reflective or partially reflective to the waves being observed or has the property of being transparent to the waves being observed.

The invention can have one or more liquid pumps (22) that can have one or more additional pipelines connected to the dish chamber (32) at various points. The said pipelines would have valve covers that cover the orifice of the pipeline where said pipelines are connected to the dish chamber (32) flush with the surface of the interior of dish chamber (32). As more liquid substance (12) is pumped into the dish chamber (32) and the liquid substance covers or passes an additional pipeline the said valve cover of that pipeline would open and allow the liquid pump (22) to pump additional liquid substance (12) into the dish chamber (32) through that additional pipeline. This would allow for a more rapid growth of the liquid mirror with out collapsing the meniscus (14).

The invention can have one or more gas pumps (21) that can have one or more additional pipelines connected to dish chamber (32) at various points. The said pipelines would have valve covers that cover the orifice of the pipelines where said pipelines are connected to the dish chamber (32) flush with the surface of the interior of the dish chamber (32). This would allow for a more rapid growth of the liquid mirror with out collapsing the meniscus (14).

The invention would have one or more centrifuge pumps (23) that can have one or more additional pipelines connected to the dish chamber (32) at any point. The said pipelines would have valve covers that cover the orifice of the pipelines where said pipelines are connected to the dish chamber (32) flush with the surface of the interior of the dish chamber (32). This would allow for the centrifuge chamber (53) to quickly and thoroughly remove and separate all of the gas substance (11) and the liquid substance (12) from the dish chamber (32).

The lip (70) can extent inward from the dish chamber (32) at various degrees ranging from 1 degree to 179 degrees. Additionally, the lip (70) may also be comprised in part or in all of a meniscus grabbing material being sponge like having pours that the meniscus (14) can penetrate. Therefore, the meniscus grabbing material creates a greater adhesion between the lip (70) and the meniscus (14). Additionally, the lip (70) could be composed of a material similar to a hair brush having multiple bristles allowing more surface area for the meniscus (14) to adhere to. Therefore, the meniscus grabbing material creates a greater adhesion between the lip (70) and the meniscus (14). Furthermore, the lip (70) and or the dish chamber (32) could have crevices that extend into the surface allowing more surface area for the meniscus (14) to adhere to. Therefore, the meniscus grabbing material creates a greater adhesion between the lip (70) or the dish chamber (32) and the meniscus (14). Additionally, the interior surface of dish chamber (32) and or the lip (70) can have micro capillaries or very small channels in the surface to aid in the adhesion of the meniscus to the surface of the dish chamber (32) and or the lip (70).

The lip (70) can have various forms and shapes. Said lip (70) at its tip could have an extension that extends inward towards the meniscus (14) or outward away from the meniscus (14). The said extension could extend from the lip (70) at various degrees ranging from 1 degree to 359 degrees. Additionally, the surface texture of the dish chamber (32) and the lip (70) could have various degrees of surface roughness and smoothness to enhance the ability of the meniscus (14) to bond to a particular point of the lip (70). The meniscus (14) may move long the lip (70) and adhere to it at any given point. The lip (70) and or various portions of said lip can be wetted and or non-wetted by liquid substance (12).

A valve can allow liquid substance (12) that is trapped on the outer side of lip (70) to reach the bottom of dish chamber (32) during rotation. Additionally, the area surrounding the lip (70) would be slanted so that when a force is applied to the system through propulsion, centrifugal force due to momentum wheels rotating the system or internal masses being moved the liquid substance would be forced to the lowest point where the vale would be located to allow any liquid substance (12) to flow to the bottom of the dish chamber (32), that is at the point dish chamber that is the greatest distance away from the center of mass of the invention.

When using a liquid substance (12) that is partially transparent such as liquid helium, liquid oxygen, liquid Neon, liquid Argon, liquid Krypton, liquid Xenon, or other substances the interior of the dish chamber (32) and the lip (70) is composed or a material that absorbs the light waves being observed and or is painted jet black so that the only reflection is from the surface of the meniscus (14). This would allow the observation of various wave frequencies, such as far infrared light waves. The gas substance (11) can be a gas like air, hydrogen, helium or various other gases or liquids.

A temperature control system can maintain all parts of the liquid space telescope at any desired temperature. The liquid substance (12) could be kept at a constant temperature to maintain it in a liquid form or it could be allowed to cool to a solid form. Although allowing liquid substance (12) to cool to a solid form may cause imperfections in the geometry and surface smoothness that would diminish the reflective properties of the dish.

By freezing liquid substance (12) after the desired size and geometry is achieved the invention can also be used to form a mold that could be used to form metal or glass reflective mirror dishes.

If mercury or a mercury alloy is used for liquid substance (12) the section of the interior of dish chamber (32) that is wetted can be constructed out of or coated with a mercury alloy and or mercury oxide alloy and or sapphire and or oxidized chromium and or other substance or alloy so as to make said surface wetted by said mercury or mercury alloy liquid substance (12).

When in microgravity the meniscus (14) forms a geometry that is spherical and non-parabolic or non-hyperbolic. This can lead to a problem known as spherical aberration. Spherical aberration is when a reflective dish has a spherical geometry light waves being reflected off the dish at various radius from the center have different or various focal points that tends to blur the image. However, there are many ways to overcome this problem. First, if the primary microgravity liquid mirror dish is small enough being less than 130 meters in diameter then a solid glass secondary dish that has the correct geometry could be used to make corrections and cancel out the spherical aberrations. If the primary microgravity liquid mirror dish is larger than 130 meters in diameter then a segmented glass secondary dish that has the correct geometry could be used to make corrections and cancel out the spherical aberrations. Second, the liquid substance (12) can be a ferro liquid and the meniscus can be altered to a parabolic or hyperbolic geometry using magnetic fields that have a predetermined spatial variation. Third, once the meniscus (14) has formed to the desired size and approximate desired geometry the system could be caused to rotate by means of a momentum wheel about an axis that is parallel to the incoming light waves being observed and passing through the center of the microgravity liquid mirror dish. The rotation of the system would cause a centrifugal force that would cause the meniscus to form a parabolic geometry. Fourth, by elongating the telescope and the microgravity liquid mirror dish having a very flattened out spherical geometry the focal distance can be lengthened to a length that nullifies the spherical aberration.

The formation of a microgravity liquid mirror dish would have to be in a near zero gravity environment. Great care would need to be taken to reduce any perturbations on the spacecraft and to reduce any internal motions.

Once formed a microgravity liquid mirror dish in liquid form would have to be moved very slowly in order to prevent it from collapsing. For example, when maneuvering the dish to a new target the attitude would have to be changed very slowly to maintain the geometry. However, a smaller solid secondary dish could be moved to change the target while the main liquid dish remained stationary. Additionally, during station keeping the meniscus (14) would probable have to be allowed to collapse and then reformed after the boost maneuver is completed. However, conventional surveillance satellites are usually down during station keeping and maneuvering. And reforming the liquid mirror dish may only take a few minutes depending on the size of the dish.

If the meniscus (14) collapses or a boost maneuver is needed the centrifuge pump (23) could pump all of both the gas substance (11) and the liquid substance (12) from the dish chamber (32) into the centrifuge chamber (53). The centrifuge chamber (53) has means to separate the substances. The centrifuge chamber (53) also has means to pump the separated gas substance (11) back to the gas chamber (51) along the gas tube (55). The centrifuge chamber (53) also has means to pump the separated liquid substance (12) back to the liquid chamber (52) along the liquid tube (54). Then a new liquid mirror dish can be formed when desired.

During a boost maneuver the dish chamber (32) can have an attitude so that when the thrust occurs the liquid substance (12) is pushed to the bottom of the dish chamber (32) and then when the thrust is stopped the thrust would be reduced slowly so that the liquid substance (12) would slowly rise along the wall of the dish chamber (32) to be stopped by the boundary line without the meniscus collapsing.

The gravitational attraction between the gas substance (11) and the liquid substance (12) and the structure of the system could effect the geometry of the meniscus (14). To compensate for this the one or more gravity equalizer (97) is connected to dish chamber (32) and has means to counter act the effect of gravity induced by the systems structural mass by structural design and placement of dead masses. The gravity equalizer has means to make the center of mass of the total system and or spacecraft to be at the center of the ½ bubble. The gravity equalizer has means to move masses so as to reduce the altering of the geometry of the ½ bubble caused by gravitational attraction between the substances and the structure of the system. The Moon can due to its gravitational attraction cause high and low tides of bodies of water on the Earth. Similarly, an external body such as the Moon could cause minute shifts in the geometry of the meniscus (14). The gravity equalizer (97) has means to move masses to counteract to gravitational attraction of an external body such as the Moon on the meniscus (14).

As the gas substance (11) and the liquid substance (12) move they move the structure of the system, which then changes the relative positions between the substances and the structure. This could cause the collapse of the meniscus (14). However, one or more inertia nullifiers (68) are connected to the dish chamber (32) and have the means to move a mass or masses with equal momentum in the opposite vector of the motion of the gas substance (11) and the liquid substance (12) and any other motions. Therefore, the inertia nullifiers (68) cancel out any affect of the motion of the gas substance (11) and the liquid substance (12) on the geometry of the meniscus (14). Additionally, the inertia nullifiers (68) has means to produce waves in the gas substance (11) and the liquid substance (12) that are opposite to waves in the gas substance (11) and the liquid substance (12) caused by perturbations or particles having mass hitting the liquid space telescope. Therefore, the inertia nullifiers have means to cancel out said waves caused by perturbations. Additionally, the inertia nullifiers have the means to move masses that can be moved during the turning of the microgravity liquid mirror dish or telescope or the entire spacecraft so that the liquid substance is pushed to the bottom of the dish chamber below the boundary line so that the liquid substance remains stable during the turning maneuver, and once the turning maneuver begins and centrifugal force is keeping the liquid substance at the bottom of the dish chamber the masses can be slowly moved back to the original position of the masses and the masses can be controlled automatically via the main computer and or a remote human controller.

The geometry of the microgravity liquid mirror dish should be nearly perfect in true zero g. However, when in liquid form even minute forces applied to a system could cause wave effects in the surface of the meniscus (14) that could cause decreased perfection of the geometry. This could be overcome by providing an outer shell (93) that absorbs external perturbations. Additionally, the outer shell (93) has an outer aperture cover (94) that is transparent to the wave being observed. The outer shell (93) has means to grapple the dish or telescope contained within so as to have a ridged connection for boost maneuvers. The outer shell (93) can grapple the inner telescope during rotation maneuvers. The outer shell (93) would track the movement of the internal telescope (in complete free fall) and using propulsion means move in relation to the internal telescope. This achieves a highly reduced external perturbation effect on the telescope providing a near 0 g environment for the telescope. The outer shell can be constructed of a flexible material so that the outer shell can be folded up into a compact space for launch and then inflated once in outer-space and can have an outer aperture cover that makes the outer shell sealed and can be inflated like a balloon using the gas substance and or any other gas or the walls of the outer shell can be cellular and can be inflated so that no outer aperture cover is needed so that the liquid substance (12) is open to the vacuum of space and can be controlled automatically via the main computer and or a remote human controller.

If a rapid attitude change is needed an elongated cylindrical section of the dish chamber (32) can be provided. The meniscus (14) can be moved to be in the center of the elongated cylindrical section of the dish chamber (32). While the meniscus (14) is in the elongated cylindrical section of the dish chamber (32) rapid attitude change could be achieved without causing the meniscus (14) to collapse. The meniscus (14) would simply alter its orientation relative to the elongated cylindrical section of dish chamber (32). Once the attitude change was completed the meniscus (14) would be quickly reoriented to the elongated cylindrical section of dish chamber (32). Then the meniscus (14) can be moved back to its original position. The microgravity liquid mirror dish can work given a large range of pressure within dish chamber (32).

It should be understood that some of the components of the current invention may not be necessary especially in smaller scales. For example, the outer shell, gravity equalizer and inertia nullifier may not be necessary.

When the meniscus (14) is moving along the section of dish chamber (32) having changing radius the meniscus (14) can form a desired geometry dependant on the contact angle of the meniscus (14) to the surface of the dish chamber (32). The contact angle of the meniscus (14) to the surface of the dish chamber can range from 0 to 360 degrees. Additionally, the change in the radius can vary from 1 to 89 degrees. Furthermore, the rate of the radius change can vary and can increase or decrease forming various geometries. For example, geometries can range from a slightly curved concave dish to a convex geometry radiating outward from the center like a whirlpool or tornado geometry.

The inner aperture cover (90) and the outer aperture cover (94) can be constructed of a material or coated in a material that reduces glare or reflection off of said covers. Additionally, said covers can be mounted so as to be at a slight angle from being perpendicular to the waves or rays being observed so as to not impose glare or unwanted reflection into the dish or image.

The inner aperture cover (90) and the outer aperture cover (94) can have means to open up to expose the liquid substance (12) to the near vacuum of space and not block the aperture (80). First, the liquid substance (12) would be allowed to form the desired geometry then the dish chamber (32) would slowly de-pressurized to closely match the near vacuum of space and then said covers would be opened. The liquid substance (12) would maintain its position due to its wetting the interior surface of the dish chamber (32) which would be the only force acting on it and if the liquid substance (12) dose not wet said surface then the inertia of the liquid substance (12) shall stop it from escaping since no other forces are acting on said liquid substance (12). Additionally, the liquid substance (12) can be a Ferro fluid and a magnetic field generated behind the liquid substance (12) to aid in keeping the liquid substance (12) from escaping into space.

Once in space and microgravity, liquid substance (12) can be already depressurized to near vacuum and or can be depressurized to near vacuum by liquid pump (22) while liquid substance (12) is still inside of liquid chamber (52). Then, liquid substance (12) would slowly be pumped into dish chamber (32). The liquid substance (12) would maintain its position due to its wetting the interior surface of dish chamber (32) that would be the only force acting on it and if the liquid substance (12) dose not wet said surface then the inertia of the liquid substance (12) shall stop it from escaping since no other forces are acting on said liquid substance (12). Additionally, the liquid substance (12) can be a Ferro fluid and a magnetic field generated behind the liquid substance (12) can aid in keeping liquid substance (12) from escaping into space. Additionally, by rotating the telescope and or the entire spacecraft centrifugal force would prevent the liquid substance (12) from escaping into space while being pumped in to the dish chamber (32).

One or more electrical conductive rods that are insulated by electrical resistive material, such as rubber, except at said rods tip. The rods can be mounted to the interior of the dish chamber (32) so that the said tip is in contact with the liquid substance (12) while liquid substance (12) is inside of the dish chamber (32). The said tip would not be in contact with the dish chamber (32). Additionally, said rods would not penetrate the meniscus (14) of the liquid substance (12) when the meniscus (14) is in a desired geometry so as to not disturb the meniscus (14). The liquid substance (12) would be an electrical conductive liquid. All or various parts of the dish chamber (32) and or the interior surface of the dish chamber (32) would also be electrically conductive. Additionally, all or various parts of the lip (70) and or the surface of the lip (70) would also be electrically conductive. An electrical DC and or AC current would be sent through the liquid substance (12) into the dish chamber (32) and or the lip (70). This can alter the electrostatic bond between the liquid substance (12) and the interior surface of the dish chamber (32) and or the lip (70). This can serve several purposes, such as, by increasing the electrostatic bond, the liquid substance (12) would be prevented from escaping into space if no inner aperture cover (90) and outer aperture cover (94) are used. Additionally, multiple sections and or layers of the surface of the dish chamber (32) and or the lip (70) can be sectioned off by electrically resistive material and each said section can have variable control of its conductivity by use of variable control resisters. The said separate sections would be disposed all about the interior surface and or at the points where the meniscus (14) contacts said dish chamber (32) and or surface of said lip (70). This configuration would allow for various sections where the liquid substance (12) contacts the interior surface of the dish chamber (32) and or the lip (70) to have varying electrostatic attraction. By varying the resistance in each section as electricity is passed though said sections greater precision control over the precision of the geometry of the meniscus (14) can be achieved. A computer can control and maintain this processor the process can be controlled remotely by a human.

The invention would have multiple micro adjusters that are disposed about the exterior circumference of the dish chamber (32). The boundary line and each micro adjuster is connected at two or more points to the dish chamber (32) and or boundary line. Each micro adjuster can apply tension or push to the dish camber (32) and or boundary line at the two points said micro adjuster is connected, and the micro adjusters have the means to alter the geometry of dish chamber (32) and or the boundary line so as to be more precisely circular. The multiple micro adjusters can be disposed about the exterior circumference of the boundary line being connected at two points on opposite sides of the boundary line in which the meniscus (14) contacts the boundary line, and each micro adjuster can apply tension or push to the dish camber (32) and or boundary line at the two points said micro adjuster is connected, and the micro adjusters have the means to alter the geometry of the dish chamber (32) and or the boundary line so as to control the boundary line to be a more perfectly level and in an even plane and to have a constant contact angle where the meniscus (14) meets the boundary line, and all micro adjusters can be controlled automatically via the main computer and or a remote human controller;

All surfaces of the interior of the dish chamber (32) that doses not contact the liquid substance (12) when forming a dish dose not wet the liquid substance (12) to reduce liquid substance (12) from sticking to it.

The diameter of the microgravity liquid mirror dish formed by the meniscus (14) could super seed state of the art reflective dishes in size limitation.

A tube can be at the center of the meniscus (14) to allow waves to be reflected off of the meniscus (14) then reflected off of a secondary mirror dish and then reflected back though the tube and the center of the meniscus (14).

The invention would have two or more momentum wheels that have the means to exchange angular momentum with the microgravity liquid mirror dish or the telescope or the entire spacecraft and or any other attitude control actuation system that can rotate the microgravity liquid mirror dish or the telescope or the entire spacecraft about an axis that is at the center of the primary liquid mirror dish and is perpendicular to the plane of the boundary line that would cause a centrifugal force to be applied to the liquid substance (12) that can control the geometry of the meniscus (14), and that has the means to rotate the liquid mirror dish or telescope or the entire spacecraft about an axis that passes through the above mentioned axis but is beyond the boundary line and is parallel to plane of the boundary line and is between the primary and secondary microgravity liquid mirror dishes that causes the liquid substance (12) to be pushed to the bottom of the dish chamber (32) during rotation to bring a new target into sight and can be controlled automatically via the main computer and or a remote human controller.

The invention would have one or more electromagnets that can generate a magnetic field that can be used to alter the geometry of the meniscus (14) when the liquid substance (12) is a Ferro-liquid and can be controlled automatically via the main computer and or a remote human controller.

The invention would have one or more electromagnets that can generate a magnetic field all about the liquid space telescope to reduce the effect of perturbations on the liquid space telescope and can be controlled automatically via the main computer and or a remote human controller.

The invention would have one or more liquid substance removal units that have the means to move about the interior of the dish chamber (32) and or liquid space telescope and or outer shell through the use of thrusters using compressed gas substance (11) and or any other type of propulsion and or though mechanical means, and the liquid substance removal units have a transceiver wireless connection to the main computer and are computer controlled and or remotely human controlled and can detect any liquid substance that is stuck to the inner and or outer aperture covers or any other surface of the dish chamber and or liquid space telescope and or outer shell using cameras and or any other sensory system and can remove any liquid substance (12) that gets stuck to the inner and or outer aperture covers or any other surface of the dish chamber and or liquid space telescope and or outer shell by means of a squeegee and or suction and then return the liquid substance to the liquid chamber though one of the liquid pipe lines, and the liquid substance removal units have means to dock with one or more internal docking ports to refuel gas substance and or any other propellant and recharge a power supply and can be controlled automatically via the main computer and or a remote human controller.

The invention would have one or more external docking ports that allow a replacement liquid space telescope to dock and pump out any liquid substance, gas substance, propellant or any other reusable resource so as to reduce the launch cost of replacement liquid space telescopes and can be controlled automatically via the main computer and or a remote human controller.

Other embodiments of the invention will be apparent to those skilled in the art. For example, in the disclosed material many embodiments are disclosed to form the liquid space telescope and to alter the curvature of said dish. Thus, while the invention has been particularly shown and described with respect to the embodiments, it will be understood by those skilled in the art that changes in the form and details may be made therein without departing from the scope and spirit of the invention. The invention may be embodied in other specific forms without departing from the spirit or essential characteristics thereof. The present embodiments are therefore to be considered in all respects as illustrative and not restrictive, the disclosed material rather than by the foregoing description, and all changes which come within the meaning and range of equivalency of the disclosed material are therefore intended to be embraced therein. Additionally, it should be understood that reflective telescopes can be configured in many ways. Therefore, a complete telescope design is not disclosed. However, it should be understood that an entire telescope using this technology falls under the spirit of the invention and all associated patent protection. Furthermore, it should be understood that any images that are created through the use of this invention is considered to be a product of the invention's method to produce images and therefore is considered the ultimate product of the invention. Thus, any images created using the invention falls under any patent rights of the invention. Additionally, components, concepts and designs from any of the disclosed embodiments may be combined to form a new embodiment.

It should be understood by those skilled in the art that this invention may have various other applications including but not limited to focusing light from the sun or other sources to be used as a propulsion system by focusing the light directly or indirectly on to a spacecraft. The invention can be used to focus light energy from the sun or other source to transmit energy to the Earth's surface or other locations. The invention can be used to form a powerful microscope or similar device. The inventions variable focus capability can be used to focus radio, microwave and light waves for communication purposes.

I claim:

1. A liquid space telescope and the images produced that utilizes a microgravity liquid mirror dish as the primary and or secondary and or any other reflective dish in the liquid space telescope that in microgravity uses the natural effect of capillary action and surface tension of a liquid substance inside a dish chamber to form a variable focus reflective liquid mirror dish for a liquid space telescope comprising:
A spacecraft platform that has one or more thrusters and or any means of propulsion that can propel the liquid space telescope to a desired location and can provide a steady thrust that counteracts the effects of perturbations making the liquid space telescope experience virtual zero gravity and can provide a steady thrust during turning maneuvers so as to cause the liquid substance to move to the bottom of the dish chamber below the boundary line to stabilize the liquid substance during the turning maneuver and can be controlled automatically via the main computer and or a remote human controller;
One or more main computers that can automatically control any system on the liquid space telescope and or relay commands from a remote human controller through a connection to the spacecraft transceiver;
One or more spacecraft electrical power supplies that can be controlled automatically via the main computer and or a remote human controller;
One or more spacecraft attitude control sensor systems that can be controlled automatically via the main computer and or a remote human controller;
One or more spacecraft attitude control actuator systems that can be controlled automatically via the main computer and or a remote human controller;
One or more spacecraft transceiver communication systems that can relay data to and from the spacecraft and another transceiver at a distant location and can be controlled automatically via the main computer and or a remote human controller;
A gas substance that can be composed of any gas and or combination of gases that is a gas or a liquid at one temperature that the liquid substance is a liquid and has the property of being transparent to the waves being observed;
A liquid substance that can be composed of any liquid and or combination of liquids and or alloys and has the property of being reflective or partially reflective to the waves being observed and the liquid substance can have pigmentation added to it to cause it to be dark or non-transparent so that the only reflection comes off of the meniscus and the liquid substance can be a ferro-liquid;
A third intermediate substance being less dense than gas substance and denser than liquid substance can be between the gas substance and liquid substance that has the property of being reflective or partially reflective to the waves being observed or has the property of being transparent to the waves being observed;
One or more temperature control systems that can maintain all parts of the liquid space telescope at any desired temperature and the liquid substance can be kept at a constant temperature to be maintained in a liquid form or the liquid substance can be allowed to cool to a solid state;
One or more dish chambers that have a form similar to a dish or a funnel with an increasing radius that becomes truly cylindrical having a constant radius and the change in the radius can vary from 1 to 89 degrees and the rate of the radius change can vary and can increase or decrease forming various geometries and the geometries can range from a slightly curved concave dish to a convex geometry radiating outward from the center like a whirlpool or tornado and the dish chamber can be constructed of a flexible material so that the dish chamber can be folded up into a compact space for launch and then inflated once in outer space and can have a inner aperture cover so that the dish chamber is sealed and can be inflated like a balloon with the gas substance and liquid substance or that inflates the walls of the dish chamber but allows for no inner aperture cover and or outer aperture cover so that the liquid substance is open to the vacuum of space and the inflation can be controlled automatically via the main computer and or a remote human controller;
One or more microgravity liquid mirror dishes that are created by the meniscus of the liquid substance and can be controlled automatically via the main computer and or a remote human controller;
A tube that is at the center of the meniscus to allow waves to be reflected off of the meniscus then reflected off of a secondary mirror dish and then reflected back though the tube and the center of the meniscus and the surface of said tube would not be wetted by the liquid substance;
One or more boundary lines that are the lines where the meniscus in a circular configuration contacts the interior surface of the dish chamber when the meniscus is in the desired geometry for reflection and can be controlled automatically via the main computer and or a remote human controller;
A gas chamber that can have any form and is used to store the gas substance;
A gas pump that has the means to pump the gas substance from the gas chamber into the dish chamber and or pump the gas substance from the dish chamber into the gas chamber through the gas pipelines and can be controlled automatically via the main computer and or a remote human controller;
One or more gas pipelines that connect the gas pump to the dish chamber at any points in the dish chamber;
One or more valve covers that cover the orifice of the gas pipelines where said pipelines are connected to the dish chamber that are flush with the surface of the interior of dish chamber and has the means to be mechanically opened or closed and can be controlled automatically via the main computer and or a remote human controller;
A liquid chamber that can have any form and is used to store the liquid substance;
A liquid pump that has the means to pump the liquid substance from the liquid chamber into the dish chamber and or pump the liquid substance from the dish chamber into the liquid chamber though the liquid pipelines and can pump the liquid substance from the liquid chamber into the dish chamber up to the boundary line causing the meniscus to form a desired geometry for a reflective dish and can be controlled automatically via the main computer and or a remote human controller;
One or more liquid pipelines that connect the liquid pump to the dish chamber at any points in the dish chamber;
One or more valve covers that cover the orifice of the liquid pipelines where said pipelines are connected to the dish chamber that are flush with the surface of the interior of the dish chamber and has the means to be mechanically opened or closed and can be controlled automatically via the main computer and or a remote human controller;
One or more centrifuge chambers that have the means to separate the gas substance and liquid substance with a centrifuge;
One or more centrifuge pumps that has the means to pump the gas and the liquid substances from the dish chamber into the centrifuge chamber and has means to pump the separated gas substance back to the dish chamber along one or more centrifuge pipelines and or gas chamber along the gas tubes and can pump the separated liquid substance back to the liquid chamber along the liquid tubes and can be controlled automatically via the main computer and or a remote human controller;
One or more centrifuge pipelines that connect the centrifuge pump to the dish chamber at any points in the dish chamber;
One or more valve covers that cover the orifice of the centrifuge pipelines where said pipelines are connected to the dish chamber that are flush with the surface of the interior of dish chamber and has the means to be mechanically opened or closed and can be controlled automatically via the main computer and or a remote human controller;
One or more gas tubes that connect the centrifuge pumps to the gas chamber;
One or more liquid tubes that connect the centrifuge pumps to the liquid chamber;
An inner aperture cover that is part of the dish chamber and is composed of a material that is transparent to the waves being observed that would allow waves to pass thru to intersect with the meniscus and be reflected back out thru the inner aperture cover, and the inner aperture cover can be constructed of a flexible material, and the inner aperture cover can be constructed of a material or coated in a material that reduces glare or reflection off of the inner aperture cover, and the inner aperture cover can be mounted so as to be at an angle of 0.00000000001 to 89 degrees from being perpendicular to the waves being observed so as to not impose glare or unwanted reflection into the dish or image, and the inner aperture cover can have means to open and close mechanically and can be controlled automatically via the main computer and or a remote human controller or no inner aperture cover is used;
Two or more momentum wheels that have the means to exchange angular momentum with the microgravity liquid mirror dish or the telescope or the entire spacecraft and or any other attitude control actuation system that can rotate the microgravity liquid mirror dish or the telescope or the entire spacecraft about an axis that is at the center of the primary liquid mirror dish and is perpendicular to the plane of the boundary line that would cause a centrifugal force to be applied to the liquid substance that can control the geometry of the meniscus, and that has the means to rotate the liquid mirror dish or telescope or the entire spacecraft about an axis that passes through the above mentioned axis but is beyond the liquid boundary line and is parallel to plane of the boundary line and is between the primary and secondary microgravity liquid mirror dishes that causes the liquid substance to be pushed to the bottom of the dish chamber during rotation to bring a new target into sight and can be controlled automatically via the main computer and or a remote human controller;
One or more inertia nullifiers that have the means to move masses back and forth along any axis that counter balances the flow of any liquid and or gas so that the meniscus is not disturbed and masses can be moved during the turning of the microgravity liquid mirror dish or telescope or the entire spacecraft so that the liquid substance is pushed to the bottom of the dish chamber below the boundary line so that the liquid substance remains stable during the turning maneuver, and once the turning maneuver begins and centrifugal force is keeping the liquid substance at the bottom of the dish chamber the masses can be moved back to the original position of the masses and the masses can be controlled automatically via the main computer and or a remote human controller;
One or more gravity equalizers that have the means to move masses back and forth along any axis so as to counter the effects of gravity from distant objects and the gravity generated by the mass of the spacecraft telescope so to counter any effects of gravity on the geometry of the meniscus, and the masses can be controlled automatically via the main computer and or a remote human controller;
An outer shell that can have any form and is disposed all about the internal dish and or liquid space telescope and has the means to grapple the internal dish and or liquid space telescope contained within so as to have a ridged connection for boost maneuvers and has the means to release the internal dish and or space liquid telescope so that said internal dish and or liquid space telescope is not connected to the outer shell, and the outer shell has the means to track the movement of the internal dish and or liquid space telescope and using propulsion means move in relation to the internal dish and or telescope to absorb external perturbations creating a virtual zero gravity environment for the internal dish and or liquid space telescope, and the outer shell can be constructed of a flexible material so that the outer shell can be folded up into a compact space for launch and then inflated once in outer-space and can have an outer aperture cover that makes the outer shell sealed and can be inflated like a balloon using the gas substance and or any other gas or the walls of the outer shell can be inflated so that no outer aperture cover is needed so that the liquid substance is open to the vacuum of space and can be controlled automatically via the main computer and or a remote human controller;
An outer aperture cover that is part of the outer shell and is composed of a material that is transparent to the waves being observed that would allow waves to pass thru to intersect with the meniscus and be reflected back to a secondary reflective dish, and the outer aperture cover can be constructed of a material that is flexible, and the outer aperture cover can be constructed of a material or coated in a material that reduces glare or reflection off of the outer aperture cover, and the outer aperture cover can be mounted at an angle from being perpendicular to the waves being observed so as to not impose glare or unwanted reflection into the dish or image and when the telescope is in operation the outer shell is oriented so that the waves being observed can pass through the outer aperture cover to intersect with the primary microgravity liquid mirror dish, and the outer aperture cover can have means to open and close mechanically and can be controlled automatically via the main computer and or a remote human controller or no outer aperture cover is used;
One or more electromagnets that can generate a magnetic field that can be used to alter the geometry of the meniscus when the liquid substance is a ferro-liquid and can be controlled automatically via the main computer and or a remote human controller;
One or more electromagnets that can generate a magnetic field all about the liquid space telescope to reduce the effect of perturbations on the liquid space telescope and can be controlled automatically via the main computer and or a remote human controller;
Multiple micro adjusters that are disposed about the exterior circumference of the dish chamber and or the boundary line and each micro adjuster is connected at two or more points to the dish chamber and or boundary line, and each micro adjuster can apply tension or push to the dish camber and or boundary line at the two points said micro adjuster is connected, and the micro adjusters have the means to alter the geometry of the dish chamber and or the boundary line so as to be more precisely circular, and multiple micro adjusters can be disposed about the exterior circumference of the boundary line being connected at two points on opposite sides of the boundary line in which the meniscus contacts the boundary line, and each micro adjuster can apply tension or push to the dish camber and or boundary line at the two points said micro adjuster is connected, and the micro adjusters have the means to alter the geometry of dish chamber and or the boundary line so as to control the boundary line to be a more perfectly level and in an even plane and to have a constant contact angle where the meniscus meets the boundary line, and all micro adjusters can be controlled automatically via the main computer and or a remote human controller;
One or more liquid substance removal units that have the means to move about the interior of the dish chamber and or liquid space telescope and or outer shell through the use of thrusters using compressed gas substance and or any other type of propulsion and or though mechanical means, and the liquid substance removal units have a transceiver connection to the main computer and are computer controlled and or remotely human controlled and can detect any liquid substance that is stuck to the inner and or outer aperture covers or any other surface of the dish chamber and or space liquid telescope and or outer shell using cameras and or any other sensory system and can remove any liquid substance that gets stuck to the inner and or outer aperture covers or any other surface of the dish chamber and or liquid space telescope and or outer shell by means of a squeegee and or suction and then return the liquid substance to the liquid chamber though one of the liquid pipe lines, and the liquid substance removal units have means to dock with one or more internal docking ports to refuel gas substance and or any other propellant and recharge a power supply and can be controlled automatically via the main computer and or a remote human controller;
One or more external docking ports that allow a replacement liquid space telescope to dock and pump out any liquid substance, gas substance, propellant or any other reusable resource so as to reduce the launch cost of replacement liquid space telescopes and can be controlled automatically via the main computer and or a remote human controller;

2. The invention as stated in claim 1 wherein:
The boundary line consist of the bottom section of the dish chamber being constructed of a material and or coated in a material that wets the liquid substance and a circular boundary line about the interior of the dish chamber that transitions to non-wetting the liquid substance, and the meniscus geometry can then be controlled by altering the volume of the liquid substance in the dish chamber, and all surfaces of the interior of the dish chamber, liquid space telescope and outer shell that doses not contact the liquid substance when forming a dish can be constructed of a material and or coated in a material that dose not wet the liquid substance;

3. The invention as stated in claim 1 wherein:
The boundary line consist of a lip that is connected to the dish chamber about the interior circumference of said dish chamber and can extend in towards the center of the dish chamber at various degrees ranging from 1 degree to 179 degrees and the lip at its tip could have an extension that extends inward towards the center of the dish chamber or outward away from the center of the dish chamber, and the extension could extend from the lip at various degrees ranging from 1 degree to 359 degrees, and one or more release pipelines that can allow any liquid substance that is trapped on the outer side of the lip to reach the bottom of the dish chamber and one or more release valve covers that cover the orifices of the release pipelines where said pipelines are connected to the dish chamber that are flush with the surface of the interior of dish chamber and has the means to be mechanically opened or closed and forms an aperture that is circular in form and the outermost edge of the lip can be like a razors edge and or the outer surface on the edge of lip can be composed of and or coated with a material that creates a wetting non-wetting boundary, and the lip can be comprised in part or in all of a meniscus grabbing material being sponge like and having pours that the meniscus can penetrate, and the lip can be composed of a material similar to a hair brush having multiple bristles allowing more surface area for the meniscus to adhere to, and the lip and or dish chamber could have capillaries or channels in the surface to aid in the adhesion of the meniscus to the surface of the dish chamber and or lip, and the surface texture of the dish chamber, and the bottom portion of the dish chamber up to the lip wets the liquid substance, and when in microgravity the meniscus rises up the sides of the dish chamber due to capillary action and the lip stops the capillary action rise and the meniscus geometry can then be controlled by altering the volume of the liquid substance in the dish chamber;

4. The invention as stated in claim 1 wherein:
The boundary line consist of a pinned lip that is a circular indented grove about the interior surface of the dish chamber that provides an edge, and the bottom portion of the dish chamber up to the pinned lip wets the liquid substance, and when in microgravity the meniscus rises up the sides of the dish chamber due to capillary action the pined lip stops the capillary rise because there is no more surface to rise onto, and the meniscus geometry can then be controlled by altering the volume of the liquid substance in the dish chamber;

5. The invention as stated in claim 1 wherein:
The boundary line utilizes the contact angle of the meniscus to the wall of the dish chamber and or lip to control the geometry of the meniscus and the contact angle can vary ranging between 0 and 360 degrees and by controlling the volume of the liquid substance in the dish chamber the meniscus can be controlled to contact the surface of the wall of the chamber and or lip at any given contact angle ranging from 1 to 360 degrees;

6. The invention as stated in claim 1 wherein:
The boundary line consist of a lip that extends down toward the bottom of the dish chamber and the dish chamber and or lip is not wet by the liquid substance and a section of the dish chamber that is bellow the contact point of the meniscus when the meniscus is in the desired geometry wets the liquid substance and there is a void between the lip and the wall of the dish chamber and when the meniscus reaches the end or tip of the lip the meniscus can not move forward into the area that surrounds the lip then a gas pump pumps the gas substance from the area surrounding the lip into the gas chamber that allows the liquid substance to move into the area that surrounds the lip and then the gas pump would very slowly pump the gas substance from the gas chamber into the dish chamber and simultaneously the liquid pump would very slowly pump the liquid substance from the dish chamber into the liquid chamber causing the meniscus to reverse direction and then the meniscus would be pinned to the end of the lip because the meniscus would have no where else to adhere to and then the geometry of the meniscus would begin to be altered to form a concave meniscus and would allow for various amounts of curvature of the meniscus to be achieved and once the desired geometry is achieved the gas pump and liquid pump would stop pumping;

7. The invention as stated in claim 1 wherein:
One or more electrical conductive rods that are insulated by electrical resistive material except at said rods tip are mounted to the interior of the dish chamber so that the said tip is in contact with the liquid substance while said liquid substance is inside of the dish chamber, and the tip would not be in contact with dish chamber, and the electrical conductive rod would not penetrate the meniscus of the liquid substance when the liquid substance is in a desired geometry so as not to disturb the meniscus, and the liquid substance would be an electrical conductive liquid, and all or various parts of dish chamber would also be electrically conductive and all or various parts of the boundary line would also be electrically conductive and an electrical DC and or AC current can be sent through the liquid substance into the dish chamber and or boundary line, and multiple sections and or layers of the surface of the dish chamber and or boundary line can be sectioned off by electrically resistive material and each said section can have variable control of its conductivity by use of variable control resisters, and said separate sections would be disposed all about the interior surface and or at the points where the meniscus contacts said dish chamber and or surface of said boundary line, and all of the electrical flow can be controlled automatically via the main computer and or a remote human controller;
